(19) United States
(12) Patent Application Publication
(10) Pub. No.: US 2011/0302904 A1
(43) Pub. Date: Dec. 15, 2011

(54) Pulsed Detonation Cleaning Device with Multiple Folded Flow Paths

(75) Inventors: Tian Xuan Zhang, Raytown, MO (US); David Michael Chapin, Raytown, MO (US); Miles Alan Peregoy, Raytown, MO (US)

(73) Assignee: GENERAL ELECTRIC COMPANY, Schnectady, NY (US)

(21) Appl. No.: 12/813,735

(22) Filed: Jun. 11, 2010

(51) Int. Cl. F02C 5/02

(52) U.S. Cl. 60/39.38

(57) ABSTRACT

The present application provides a pulsed detonation cleaning device. The pulsed detonation cleaning device may include an air inlet, a fuel inlet, an ignition device in communication with the air inlet and the fuel inlet for creating detonation waves, a number of folded flow paths in communication with the ignition device, and a number of flow turning devices positioned about the folded flow paths such that the detonation waves reverse direction a number of times.

### TECHNICAL FIELD

The present application relates generally to a pulsed detonation cleaning device and more particularly relates to a cyclically pulsed detonation cleaning device having multiple folded flow paths extending therethrough.

### BACKGROUND OF THE INVENTION

Industrial boilers operate by using a heat source to create steam from water or another type of a working fluid. The steam may be used to drive a turbine or other type of load. The heat source may be a combustor that burns a fuel-air mixture therein. Heat may be transferred to the working fluid from the combustor via a heat exchanger. Burning the fuel-air mixture, however, may generate residues on the surface of the combustor, the heat exchanger; and the like. Such deposits of soot, ash, slag, or dust on the heat exchanger surfaces may inhibit the efficient transfer of heat to the working fluid. This reduction in efficiency may be reflected by an increase in the exhaust gas temperature from the backend of the process as well as an increase in the fuel burn rate required to maintain steam production and energy output. Periodic removal of the deposits thus may help maintain the efficiency of such a boiler system. Typically, the complete removal of the deposits generally requires the boiler to be shut down while the cleaning process is performed.

Pressurized steam, water jets, acoustic waves, mechanical hammering, and other methods having been used to remove these internal deposits. More recently, detonative combustion devices have been employed. Specifically, a pulsed detonation combustor external to the boiler may be used to generate a series of detonations or quasi-detonations that may be directed into the boiler. The high speed shockwaves travel through the boiler and loosen the deposits from the surface therein. The pulsed detonation combustor systems, however, tend to require a large footprint, generally operating infrequently, and may require oxygen enrichment.

There is thus a desire therefore for a boiler cleaning system that is able to operate quickly to remove internal deposits so as to minimize downtime. It is further desirable that the system may operate within the boiler environment, i.e., that the system is able to fit physically within the existing space restrictions while being able to reach all portions of the boiler that require cleaning. Moreover, such a cleaning system should not interfere with the operation of the boiler.

### SUMMARY OF THE INVENTION

The present application thus provides a pulsed detonation cleaning device. The pulsed detonation cleaning device may include an air inlet, a fuel inlet, an ignition device in communication with the air inlet and the fuel inlet for creating detonation waves, a number of folded flow paths in communication with the ignition device, and a number of flow turning devices positioned about the folded flow paths such that the detonation waves reverse direction a number of times.

The present application further provides a pulsed detonation cleaning device. The pulsed detonation cleaning device may include an air inlet, a fuel inlet, an ignition device in communication with the air inlet and the fuel inlet for creating detonation waves, an inner flow path in communication with the ignition device, a first flow turning device in communication with the inner flow path, an intermediate flow path in communication with the first flow turning device, a second flow turning device in communication with the intermediate flow path, and an outer flow path in communication with the second flow turning device.

The present application further provides a pulsed detonation cleaning device. The pulsed detonation cleaning device may include an air inlet, a fuel inlet, an ignition device in communication with the air inlet and the fuel inlet for creating detonation waves, a number of folded flow paths in communication with the ignition device, and a number of shock reflection or shock focusing devices positioned about the folded flow paths so as to accelerate the creation of the detonation waves.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a pulsed detonation cleaning system.

FIG. 2 is a side cut away view of a pulsed detonation cleaning system as may be described herein.

FIG. 3 is a side cross-sectional view of the pulsed detonation cleaning system of FIG. 3.

### DETAILED DESCRIPTION

As used herein, the term “pulsed detonation combustor” (“PDC”) refers to a device or a system that produces both a pressure rise and a velocity increase from the detonation or quasi-detonation of a fuel and an oxidizer. The PDC may be operated in a repeating mode to produce multiple detonations or quasi-detonations within the device. A “detonation” may be a supersonic combustion in which a shock wave is coupled to a combustion zone. The shock may be sustained by the energy release from the combustion zone so as to result in combustion products at a higher pressure than the combustion reactants. A “quasi-detonation” may be a supersonic turbulent combustion process that produces a pressure rise and a velocity increase higher than the pressure rise and the velocity increase produced by a sub-sonic deflagration wave. For simplicity, the terms “detonation” or “detonation wave” as used herein will include both detonations and quasi-detonations.

Exemplary PDC's, some of which will be discussed in further detail below, include an ignition device for igniting a combustion of a fuel/oxidizer mixture and a detonation chamber in which pressure wave fronts initiated by the combustion coalesce to produce a detonation wave. Each detonation or quasi-detonation may be initiated either by an external ignition source, such as a spark discharge, laser pulse, heat source, or plasma igniter, or by gas dynamic processes such as shock focusing, auto-ignition, or an existing detonation wave from another source (cross-fire ignition). The detonation chamber geometry may allow the pressure increase behind the detonation wave to drive the detonation wave and also to blow the combustion products themselves out an exhaust of the PDC.

Various chamber geometries may support detonation formation, including round chambers, tubes, resonating cavities, reflection regions, and annular chambers. Such chamber designs may be of constant or varying cross-section, both in area and shape. Exemplary chambers include cylindrical tubes and tubes having polygonal cross-sections, such as, for example, hexagonal tubes. As used herein, “downstream” refers to a direction of flow of at least one of the fuel or the oxidizer.

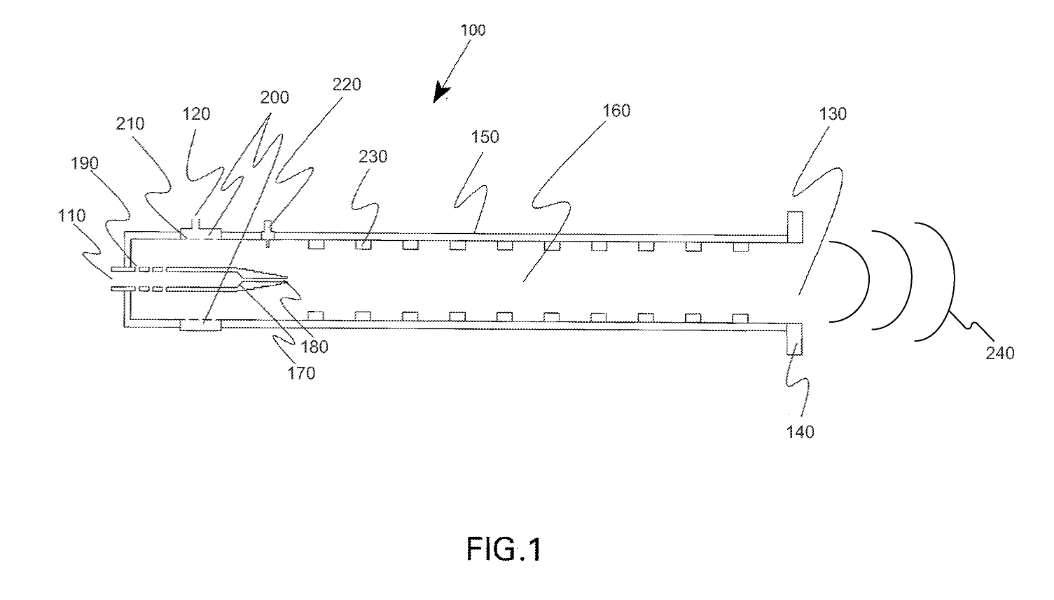

Referring now to the drawings, in which like numbers refer to like elements throughout the several views, FIG. 1 shows an example of a pulsed detonation combustor cleaner 100. The PDC cleaner 100 may extend along the illustrated x-axis from an upstream head end that includes an air inlet 110 and a fuel inlet 120 to an exit aperture 130 at a downstream end. The aperture 130 of the PDC cleaner 100 may be attached to a wall 140 of a boiler or other structure to be cleaned. A tube 150 may extend from the head end to the aperture 130 so as to define a combustion chamber 160 therein. The air inlet 110 may be connected to a source of pressurized air. The pressurized air may be used to fill and purge the combustion chamber 160 and also may serve as an oxidizer for the combustion of the fuel.

The air inlet 110 may be connected to a center body 170 that may extend along the axis of the tube 150 and into the combustion chamber 160. The center body 170 may be in the form of a generally cylindrical tube that extends from the air inlet 102 and tapers to a downstream opening 180. The center body 170 also may include one or more air holes 190 along its length. The air holes 190 may allow the air flowing through the center body 170 to enter into the upstream end of the chamber 160. The opening 180 and the air holes 190 of the center body 170 may allow for directional velocity to be imparted to the air that is fed into the tube 150 through the air inlet 110. Such a directional flow may be used to enhance the turbulence in the injected air and also to improve the mixing of the air with the fuel present within the flow in the head end of the tube 150.

The air holes 190 may be disposed at multiple angular and axial locations about the axis of the center body 170. The angle of the air holes 190 may be purely radial to the axis of the center body 170. In other examples, the air holes 190 may be angled in the axial and circumferential directions so as to impart a downstream or rotational velocity to the flow from the center body 170. The flow through the center body 170 also may serve to provide cooling to the center body 170 so as to prevent an excessive heat buildup that could result in degradation therein.

The fuel inlet 120 may be connected to a supply of fuel that may be burned within the combustion chamber 160. A fuel plenum 200 may be connected to the fuel inlet 120. The fuel plenum 200 may be a cavity that extends around the circumference of the head end of the tube 150. A number of fuel holes 210 may connect the interior of the fuel plenum 200 with the interior of the tube 150. The fuel holes 210 may extend radially from the fuel plenum 200 and into the annular space between the wall of the tube 150 and the center body 170. As with the air holes 190, the fuel holes 210 may be disposed at a variety of axial and circumferential positions. In addition, the fuel holes 210 may be aligned to extend in a purely radial direction or may be canted axially or circumferentially with respect to the radial direction.

The fuel may be injected into the chamber 160 so as to mix with the air flow coming through the air holes 190 of the center body 170. The mixing of the fuel and the air may be enhanced by the relative arrangement of the air holes 190 and the fuel holes 210. For example, by placing the fuel holes 210 at a location such that fuel is injected into regions of high turbulence generated by the flow through the air holes 190, the fuel and the air may be more rapidly mixed so as to produce a more readily combustible fuel/air mixture. Fuel may be supplied to the fuel plenum 200 through the fuel inlet 120 via a valve that allows for the active control of the flow of fuel therethrough.

An ignition device 220 may be disposed near the head end of the tube 150. The ignition device 220 may be located along the wall of the tube 150 at a similar axial position to the end of the center body 170. This position allows for the fuel and the air coming through holes 190, 210 respectively to mix prior to flowing past the ignition device 220. The ignition device 220 may be connected to a controller so as to operate the ignition device 220 at desired times as well as providing feedback signals to monitor operations.

The tube 150 also may contain a number of obstacles 230 disposed at various locations along the length thereof. The obstacles 230 may take the form of ribs, indents, pins, or any structure. The obstacles 230 may be uniform or random in size, shape, or position. The obstacles 230 may be used to enhance the combustion as it progresses along the length of the tube 150 and to accelerate the combustion front into a detonation wave 240 before the combustion front reaches the aperture 130. The obstacles 230 shown herein may be thermally integrated with the wall of the tube 150. The obstacles 230 may include features that are machined into the wall, formed integrally with the wall (by casting or forging, for example), or attached to the wall, for example by welding. Other types of manufacturing techniques may be used herein.

Air thus enters through the air inlet 110 and passes through the downstream opening 180 and the air holes 190 of the center body 170. Likewise, fuel flows through the fuel inlets 120 and through the gas holes 210 of the fuel plenum 200. The fuel and the air are then ignited by the ignition device 220 into a combustion flow and the resultant detonation waves 240. The detonation waves 240 may extend along the length of the inner tube 270. Turbulence may be provided by the obstacles 230 therein. The detonation waves 240 then may exit via the exit aperture 130 such that the detonation waves 240 may be used for cleaning purposes in a boiler and the like. Other configurations may be used herein.

The tube 150, the obstacles 230, the center body 170, and the other elements herein may be fabricated using a variety of materials suitable for withstanding the temperatures and pressures associated with repeated detonations. Such materials may include, but are not limited to, Inconel, stainless steel, aluminum, carbon steel, and the like. Other materials may be used herein.

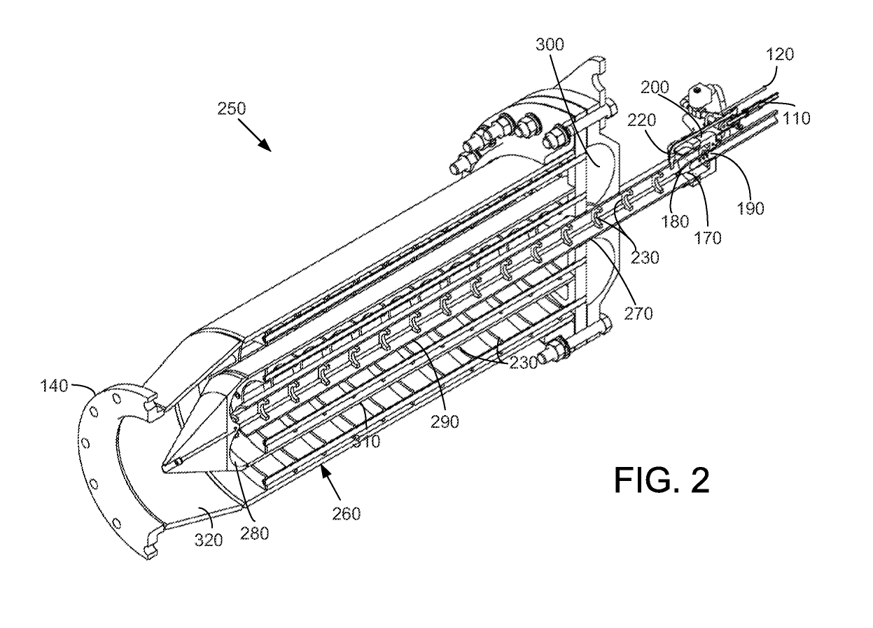

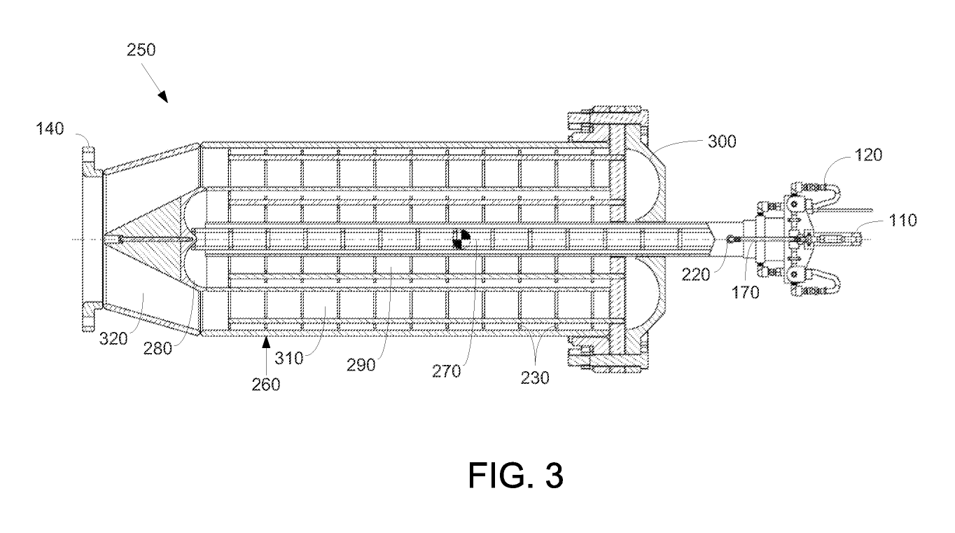

FIGS. 2 and 3 show a PDC cleaner 250 as may be described herein. Similar to the PDC cleaner 100 described above, the PDC cleaner 250 may include the air inlet 110 that leads to the center body 170. The center body 170 may include the downstream opening 180 and the number of air holes 190. Likewise, the PDC cleaner 250 may include the fuel inlet 120 that leads to the fuel plenum 200. The fuel plenum 200 and the center body 170 may be positioned near the ignition device 220. Other configurations may be used herein.

The PDC cleaner 250 also may include a multiple folded flow path 260. The multiple folded flow paths 260 may be arranged in concentric fashion. The multiple folded flow paths 260 may include a first or an inner tube 270. The inner tube 270 may be similar to the tube 150 described above. A number of the obstacles 230 may be positioned along the length of the tube 270. The center body 170, the fuel plenum 200, and the ignition device 220 may be positioned about an upstream end of the inner tube 270. A first flow turning device 280 may be positioned at the downstream end of the inner tube 270. The first flow turning device 280 may be a curved end wall or other type of structure to divert the combustion flow and/or the detonation waves 240 therethrough. The first flow turning device 280 also may act as a shock reflection or a shock focusing device to accelerate the formation of the detonation waves 240.

The first or the inner tube 270 may be surrounded by a second or an intermediate tube 290. The intermediate tube 290 also may include a number of the obstacles 230. The intermediate tube 290 may extend from the first flow turning device 280 positioned about the inner tube 270 to a second flow turning device 300 positioned at the other end thereof. The second flow turning device 300 also may be in the shape of an end wall with a curved flow path to divert the combustion flow and/or the detonation waves 240 therethrough. The second flow turning device 300 also may act as a shock reflection or a shock focusing device to accelerate the formation of the detonation waves 240.

The second or the intermediate tube 290 may be surrounded by a third or an outer tube 310. The outer tube 310 also may include a number of the obstacles 230 therein. The outer tube 310 may extend from the second flow turning device 300 to an exit aperture 320. The exit aperture 320 may have a nozzle-like shape. The exit aperture 320 may be attached to the wall 140 of a boiler or any other device to be cleaned as above.

In use, air enters through the air inlet 110 and passes through the downstream opening 180 and the air holes 190 of the center body 170. Likewise, fuel flows through the fuel inlets 120 and through the gas holes 210 of the fuel plenum 200. The flow of fuel and the flow of air are then ignited by the ignition device 220 into the combustion flow with the detonation waves 240. The detonation waves 240 may extend along the length of the inner tube 270. Turbulence may be provided by the obstacles 230 therein. The detonation waves 240 may reverse direction via the first flow turning device 280 and then pass along the length of the intermediate tube 290. Further turbulence may be provided by the obstacles 230 therein. The detonation waves 240 again may reverse direction via the second flow turning device 300 and then flow along the length of the outer tube 310. Again, turbulence may be provided by the obstacles 230 therein. The detonation waves 240 then may exit via the exit aperture 320 where the detonation waves 240 may be used for cleaning purposes in a boiler and the like. Other configurations may be used herein.

The combustion may accelerate to a detonation wave 240 in the inner tube 270 and be maintained throughout the intermediate tube 290 and the outer tube 310 before entering the vessel to be cleaned. Alternatively, the acceleration to a detonation wave 240 may occur at a point in the flow path between the exit of the inner tube 270 and the exit aperture 320 of the outer tube 310. The flow turning devices 280, 300 thus may provide shock focusing effects that may accelerate the transition to a detonation wave 240 in shorter distance than without.

The multiple fold flow path 260 may have any number of folds therein. Likewise, the flow paths 260 may take any desired size or shape. The multiple fold flow path 260 thus may generate the detonation waves 240 in a relatively small footprint. The PDC cleaner 250 thus takes less space but produces more controlled detonation energy for improved cleaning of soot, slag, and other types of surface deposits in a boiler, heat exchanger or vessel of the like.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A pulsed detonation cleaning device, comprising:
an air inlet;
a fuel inlet;
an ignition device in communication with the air inlet and the fuel inlet for creating a plurality of detonation waves;
a plurality of folded flow paths in communication with the ignition device; and
a plurality of flow turning devices positioned about the plurality of folded flow paths such that the plurality of detonation waves reverses direction a plurality of times.

2. The pulsed detonation cleaning device of claim 1, further comprising a center body in communication with the air inlet.

3. The pulsed detonation cleaning device of claim 2, wherein the center body comprises a downstream opening and a plurality of air holes.

4. The pulsed detonation cleaning device of claim 1, wherein the center body is positioned in an inner tube of the plurality of folded flow paths.

5. The pulsed detonation cleaning device of claim 1, further comprising a fuel plenum in communication with the fuel inlet.

6. The pulsed detonation cleaning device of claim 5, wherein the fuel plenum is positioned about an inner tube of the plurality of folded flow paths.

7. The pulsed detonation cleaning device of claim 1, further comprising a plurality of obstacles positioned within the plurality of folded flow paths.

8. The pulsed detonation cleaning device of claim 1, wherein the plurality of folded flow paths comprises an inner tube, an intermediate tube, and an outer tube.

9. The pulsed detonation cleaning device of claim 1, wherein the plurality of folded flow paths comprises a first tube, a second tube, and a third tube.

10. The pulsed detonation cleaning device of claim 1, wherein the plurality of folded flow paths comprises a plurality of concentric tubes.

11. The pulsed detonation cleaning device of claim 1, wherein the plurality of flow turning devices comprises a first flow turning device and a second flow turning device.

12. The pulsed detonation cleaning device of claim 1, wherein the plurality of folded flow paths comprises a combustion chamber.

13. The pulsed detonation cleaning device of claim 1, wherein the plurality of flow turning devices comprises a plurality of shock reflection or shock focusing devices.

14. A pulsed detonation cleaning device, comprising:
an air inlet;
a fuel inlet;
an ignition device in communication with the air inlet and the fuel inlet for creating a plurality of detonation waves;
an inner flow path in communication with the ignition device;
a first flow turning device in communication with the inner flow path;
an intermediate flow path in communication with the first flow turning device;
a second flow turning device in communication with the intermediate flow path; and
an outer flow path in communication with the second flow turning device.

15. The pulsed detonation cleaning device of claim 14, wherein the plurality of detonation waves comprises a first direction in the inner flow path.

16. The pulsed detonation cleaning device of claim 15, wherein the plurality of detonation waves comprises a second direction in the intermediate flow path.

17. The pulsed detonation cleaning device of claim 16, wherein the plurality of detonation waves comprises the first direction in the outer flow path.

18. The pulsed detonation cleaning device of claim 14, further comprising a plurality of obstacles positioned within the inner flow path, the intermediate flow path, and/or the outer flow path.

19. The pulsed detonation cleaning device of claim 14, wherein the inner flow path, the intermediate flow path, and the outer flow path comprises a plurality of concentric tubes.

20. A pulsed detonation cleaning device, comprising:
an air inlet;
a fuel inlet;
an ignition device in communication with the air inlet and the fuel inlet for creating a plurality of detonation waves;
a plurality of folded flow paths in communication with the ignition device; and
a plurality of shock reflection or shock focusing devices positioned about the plurality of folded flow paths so as to accelerate the creation of the plurality of detonation waves.
